(19) United States
(12) Patent Application Publication
(10) Pub. No.: US 2009/0322645 A1
(43) Pub. Date: Dec. 31, 2009

(54) Structure of an antenna holder

(75) Inventor: Sheng-Chih Sun, Taipei Hsien (TW)

Correspondence Address: BACON & THOMAS, PLLC, 625 SLATERS LANE, FOURTH FLOOR, ALEXANDRIA, VA, 22314-1176, US

(73) Assignee: WISTRON NEWEB CORP., Taipei Hsien (TW)

(21) Appl. No.: 12/385,033

(22) Filed: Mar. 30, 2009

(30) Foreign Application Priority Data
Jun. 30, 2008 (TW) 097124618

(51) Int. Cl. H01Q 1/42

(52) U.S. Cl. 343/872

(57) ABSTRACT

A structure of an antenna holder is disclosed. The antenna holder is used to protect an antenna. The antenna holder comprises a base, a holder, and a housing. The holder is disposed on the base. The holder has an engaging part. The housing comprises a first cover and a second cover. The first cover and the second cover are used to covering the antenna, wherein the second cover has a spindle. The spindle is used to insert the engaging part and let the housing fix with the holder and is able to be rotated.

### BACKGROUND OF THE INVENTION

1. Field of the Invention

The present invention relates to a structure of an antenna holder, and, more particularly, to a structure of an antenna holder having a spindle.

2. Description of the Related Art

With technologies development, wireless communication technology also has been improved rapidly. Modern antenna design requires not just good wireless transmission quality but also low manufacturing cost and nice appearance.

Please refer to FIG. 1. FIG. 1 is a structural drawing of a prior art antenna holder. In prior art technology, an antenna holder 90 for protecting an antenna is disclosed. As shown in FIG. 1, the antenna holder 90 comprises a housing 91, a holder 92 and a pin 93. The housing 91 is used for covering and protecting the antenna (not shown). The housing 91 and the holder 92 are designed to match with each other, and the pin 93 is used for holding the housing 91 and the holder 92 together and used as a revolving axle when the housing 91 is rotating. Furthermore, the pin 93 can also be directly disposed on the holder 92. However, the pin 93 requires extra manufacturing cost and also affects the appearance completeness of the antenna holder 90.

Therefore, it is desirable to provide a structure of an antenna holder to mitigate and/or obviate the aforementioned problems.

### SUMMARY OF THE INVENTION

A main objective of the present invention is to provide structure of an antenna holder, which is used for protecting an antenna.

In order to achieve the above mentioned objectives, the antenna holder of the invention comprises a base, a holder, and a housing. The holder is disposed on the base. The holder has an engaging part. The housing comprises a first cover and a second cover. The first cover and the second cover are used for covering the antenna, wherein the second cover has a spindle. The spindle is used to insert the engaging part and let the housing fix with the holder and is able to be rotated.

Other objects, advantages, and novel features of the invention will become more apparent from the following detailed description when taken in conjunction with the accompanying drawings.

### BRIEF DESCRIPTION OF THE DRAWINGS

FIG. 1 is a structural drawing of a prior art antenna holder.

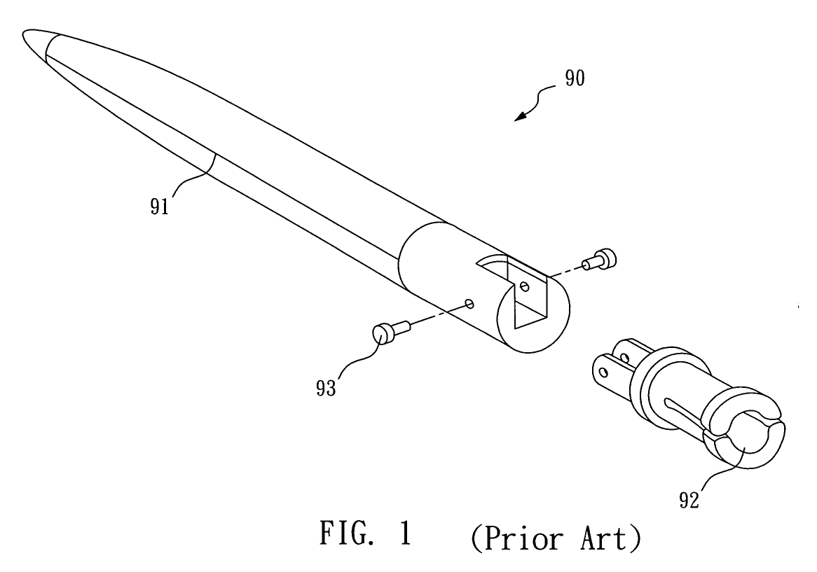

FIG. 2 is a schematic drawing of an assembly of a housing and a holder of a antenna holder according to an embodiment of the invention.

FIG. 3 is a structural drawing of the holder of the antenna holder according to an embodiment of the invention.

FIG. 4 is a structural drawing of a second cover of the housing of the antenna holder according to an embodiment of the invention.

FIG. 5A is a schematic drawing of the housing of the antenna holder being positioned at 90° according to the invention.

FIG. 5B is a schematic drawing of the housing of the antenna holder being positioned at 45° according to the invention.

FIG. 5C is a schematic drawing of the housing of the antenna holder being positioned at 0° according to the invention.

### DETAILED DESCRIPTION OF THE PREFERRED EMBODIMENT

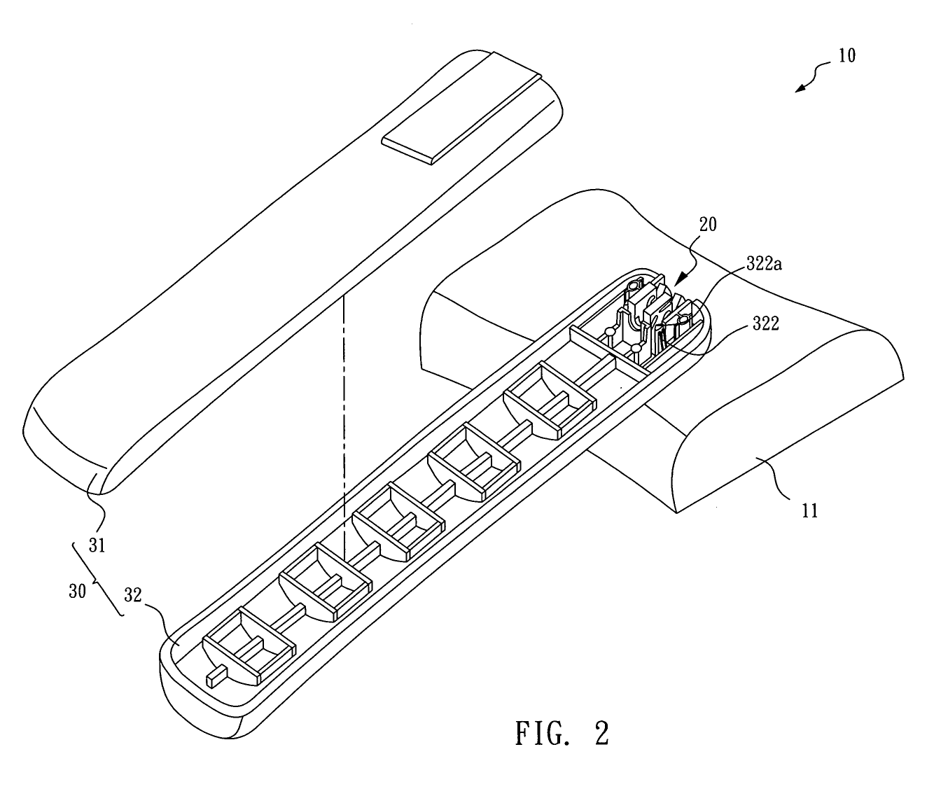

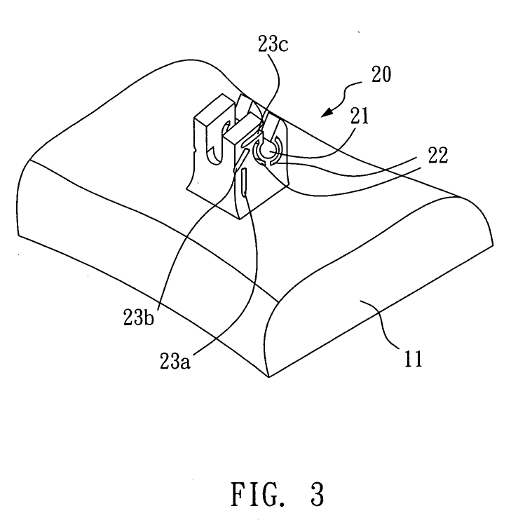

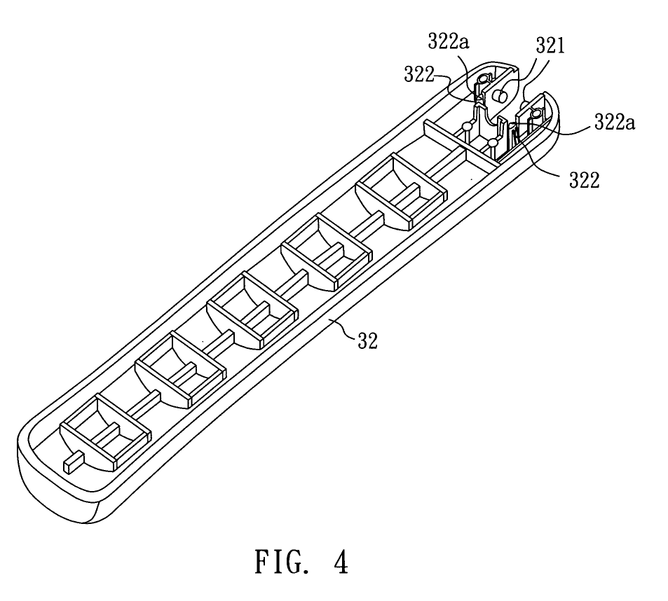

Please refer to FIG. 2 to FIG. 4. FIG. 2 is a schematic drawing of an assembly of a housing and a holder of a antenna holder according to an embodiment of the invention. FIG. 3 is a structural drawing of the holder of the antenna holder according to an embodiment of the invention. FIG. 4 is a structural drawing of a second cover of the housing of the antenna holder according to an embodiment of the invention.

As shown in FIG. 2 to FIG. 4, an antenna holder 10 is made of plastic and used for protecting an antenna (not shown). The antenna is used for transmitting digital television signals or other signals. The antenna holder 10 comprises a base 11, a holder 20 and a housing 30. The holder 20 is disposed on the base 11. The housing 30 is engaged with the holder 20, the engaged function will be descried later. The housing 30 has a first cover 31 and a second cover 32, and the first cover 31 and the second cover 32 are used for covering and protecting the antenna.

The holder 20 has an engaging part 21, a hollow structure 22 and a plurality of grooves 23a, 23b, and 23c. The second cover 32 has a spindle 321 and a positioning structure 322. The hollow structure 22 is disposed next to an opening of the engaging part 21, and used for providing flexibility for the opening of the engaging part 21. When the housing 30 needs to be assembled with the holder 20, the spindle 321 is pushed through the opening of the engaging part 21 and being engaged with the engaging part 21. With the structure of hollow structure 22, the spindle 321 can be easily pushed into the engaging part 21 to be engaged together. Therefore, with the engagement of the spindle 321 and the engaging part 21, the housing 30 is able to fix with the holder 20 and be rotated.

The second cover 32 of the housing 30 further comprises a positioning structure 322. The positioning structure 322 has the protruding portion 322a, and the protruding portion 322a is matching with the plurality of grooves 23a, 23b, and 23c. When the housing 30 is rotating, the protruding portion 322a can be engaged with one of the plurality of grooves 23a, 23b, and 23c, so the housing 30 can be positioned at a specific angle. Furthermore, the groove 23a is a positioning groove for positioning the housing 30 at 90°, the groove 23b is a positioning groove for positioning the housing 30 at 45°, and the groove 23c is a positioning groove for positioning the housing 30 at 0°. Therefore, the protruding portion 322a can be engaged individually with each of the plurality of grooves 23a, 23b, 23c, and the housing 30 can be held in a specific angle.

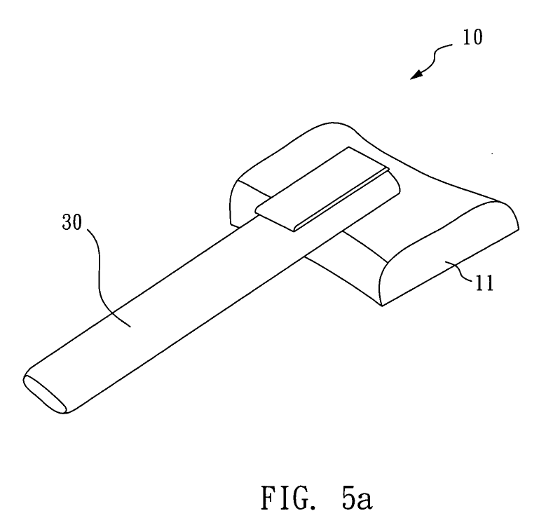

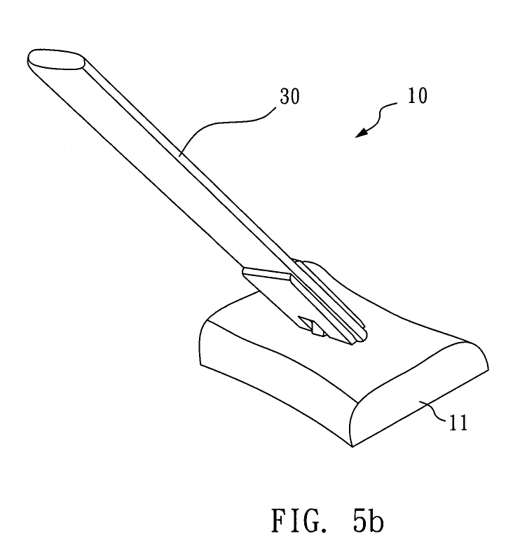

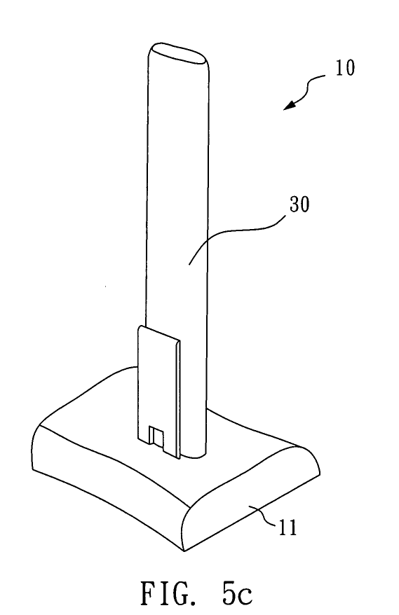

Please refer to FIG. 5A to FIG. 5C. FIG. 5A is a schematic drawing of the housing of the antenna holder being positioned at 90° according to the invention. FIG. 5B is a schematic drawing of the housing of the antenna holder being positioned at 45° according to the invention. FIG. 5C is a schematic drawing of the housing of the antenna holder being positioned at 0° according to the invention.

As shown in FIG. 5A to FIG. 5C, when the housing 30 of the antenna holder 10 is rotating, the positioning structure 322 can be engaged with the groove 23a, groove 23b, and groove 23c individually, so the housing 30 can be held at 90°, 45° and 0° three different positioning angles. Therefore, when the protruding portion 322a of the positioning structure 322 is engaged with the groove 23a, the housing 30 is firmly held at 90°. When the protruding portion 322a is engaged with the groove 23b, the housing 30 is firmly held at 45°. When the protruding portion 322a is engaged with the groove 23c, the housing 30 is firmly held at 0°.

Moreover, the holder 20 may have different number of grooves providing different positioning angles, depending on the size of the holder 20 or usage requirement.

Accordingly, the antenna holder 10 can be adjusted easily to enable the antenna to have a best positioning angle for receiving signals. Furthermore, the antenna holder 10 can reduce the tradition manufacturing cost, and the spindle 321 is hidden in the housing 30 so the antenna holder 10 has a better appearance.

Although the present invention has been explained in relation to its preferred embodiment, it is to be understood that many other possible modifications and variations can be made without departing from the spirit and scope of the invention as hereinafter claimed.

What is claimed is:

1. A structure of an antenna holder, the antenna holder being used for protecting an antenna; the antenna holder comprising:
a base;
a holder disposed on the base, the holder having an engaging part; and
a housing comprising a first cover and a second cover, the first cover and the second cover being used for covering the antenna; wherein the second cover has a spindle being engaged with the engaging part so the housing is rotatably attached to the holder.

2. The antenna holder as claimed in claim 1, wherein the holder further comprises a plurality of grooves.

3. The antenna holder as claimed in claim 2, wherein the second cover further comprises a positioning structure for being engaged with the plurality of grooves to position the housing in a specific positioning angle.

4. The antenna holder as claimed in claim 3, wherein the specific positioning angle of the housing can be substantially 90°, 45° or 0°.

5. The antenna holder as claimed in claim 3, wherein the positioning structure has a protruding portion, which is matching the plurality of grooves.

6. The antenna holder as claimed in claim 1, wherein the holder has a hollow structure.

7. The antenna holder as claimed in claim 1, wherein the antenna holder is made of plastic.
